(19) United States
(12) Patent Application Publication
(10) Pub. No.: US 2006/0032294 A1
(43) Pub. Date: Feb. 16, 2006

(54) Leak detection system for use in braking systems

(76) Inventors: John Duerr, Massapequa Park, NY (US); B. William Cooper, Lloyd Harbor, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/202,466

(22) Filed: Aug. 12, 2005

Related U.S. Application Data
(60) Provisional application No. 60/601,460, filed on Aug. 13, 2004.

(51) Int. Cl. G01M 3/20; C09K 11/06

(52) U.S. Cl. 73/40.7; 250/461.1; 252/964; 252/301.17; 141/94; 141/2

(57) ABSTRACT

In an embodiment of a method of detecting leaks in a brake system, a dyed brake fluid is introduced into the brake system; and portions of the brake system are illuminated with a light having a wavelength below about 500 nm, the light designed to cause the dye within the brake fluid to fluoresce when illuminated, thus indicating the leak.

### RELATED APPLICATION

This application is related to and claims priority from U.S. Provisional Application Ser. No. 60/601,460 filed on Aug. 13, 2004, which is incorporated herein by reference in its entirety.

### FIELD OF THE INVENTION

The present invention relates to a leak detection system for detecting leaks in a brake system.

### BACKGROUND

Systems for detecting leaks in air conditioning systems have been around for many years. The most prominent method for detecting leaks in air conditioning systems is through the use of fluorescent dyes that are added to and mix with the systems' refrigerant, and the combination circulates through the air conditioning system. This method was first pioneered by Spectronics Corporation, the assignee of the present invention. In these leak detection systems, the dye circulates through the system, eventually seeping out at the source of the leak. When exposed to a suitable light source, such as an ultraviolet (UV) light, the dye fluoresces, thus highlighting the source of the leak. U.S. Pat. Nos. 5,650,563 and 6,165,384, describe this type of existing leak detection system.

More specifically, the dyes are formulated with fluorescent additives. Fluorescence is generally understood to be a property that enables certain materials to absorb light energy and radiate visible light at a longer wavelength than the absorbed light. According to generally accepted theory, electrons in fluorescent materials are excited upon being illuminated by light energy of a specific wavelength, and light energy of a longer wavelength is radiated from these materials as the electrons return to the unexcited or ground state. The specific excitation and radiation wavelengths are characteristics of the particular fluorescent materials. The apparent brightness of a fluorescent material's luminescence is dependent on the wavelength emitted by the material and the intensity of the incident radiation that excites the material. For example, a fluorescent dye which has its excitation peak at a specific wavelength may quickly emit a much reduced luminescence as the wavelength of incident light deviates from the excitation peak, and will lose the ability to fluoresce when the incident light does not have enough energy within the specific excitation range.

The visibility of the fluorescent response is increased when the intensity of other visible light is reduced, so that the fluorescent response is not masked or washed-out by other light. Thus, ultraviolet/blue leak detection lamps directed in otherwise dark conditions at an operating system containing a UV/blue responsive fluorescent dye will reveal leak sites which glow against the dark background.

Current leak detection systems use perylene-based fluorescent compounds or naphthalimide-based fluorescent compounds. Perylene dyes produce an intense yellow fluorescent response when exposed to incident radiation in a band of the electromagnetic spectrum which includes the long wave ultraviolet (UV-A) wavelength range of about 315 nm to about 400 nm, with a strong peak between about 340 to 375 nm. Naphthalimide dyes fluoresce a brilliant green when exposed to incident radiation of visible violet/blue light. The visible violet/blue range extends from about 400 nm to about 480 nm within the electromagnetic spectrum.

Dye-based leak detection systems have, to date, been limited to detecting leaks in circulating systems, i.e., systems in which a fluid circulates. The reason is that in order for the leak detection dye to seep out at that source of the leak, the dye must find its way to that source. Thus, dye-based leak detection systems have not, to date, been used in conjunction with closed, non-circulating systems, such as brake systems. While there is limited back and forth motion in a brake system as a brake pedal is depressed and released, such motion does not circulate the fluid through the system. Thus, these systems are generally called “non-circulating systems.” In certain types of anti-lock brake system, fluid circulates in a limited part of the system, typically including a pump, a pressure relief valve, and a low-pressure reservoir. However, there are still substantial parts of the system, including fluid lines leading to the actual brakes, in which the fluid does not circulate. These types of system are therefore also regarded as “non-circulating systems.”

It has also been difficult in the past to mix dyes with braking fluids. This difficulty combined with the perceived inability to use dyes in non-circulating brake systems, has resulted in there being no activity in dye-based leak detection systems for brake systems.

A need exists for a dye-based leak detection system for use in detecting leaks in brake systems in vehicles and other devices.

### SUMMARY OF THE INVENTION

In one aspect of the present invention, there is provided a dyed brake fluid product for use in a non-circulating brake system, the product comprising a container, a brake fluid in the container, and a dye mixed with the brake fluid in the container, the dye having material properties which produce fluorescence when exposed to a light of a prescribed wavelength.

In another aspect of the invention, there is provided a method of detecting leaks in a brake system, the method comprising the steps of introducing a dyed brake fluid into a brake system, and illuminating various portions of the brake system with a light having a wavelength below about 500 nm, the light designed to cause the dye within the brake fluid to fluoresce when illuminated, thus indicating the leak.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a schematic representation of one embodiment of the invention for introducing dyed brake fluid into a brake system.

FIG. 2 is a schematic representation of an alternate embodiment of the invention for introducing dyed brake fluid into a brake system.

### DETAILED DESCRIPTION OF THE PREFERRED EMBODIMENTS

Conventional brake systems, such as those used in vehicles, typically include brake components, such as pads, drums and/or rotors, that interact with one another to stop a moving component, such as a wheel. Generally, piston-type actuators (referred to as brake cylinders) provide the force the drives the pads into engagement with the drum or rotor. The brake cylinder is part of a closed system that includes a brake fluid reservoir and fluid lines that extend from the reservoir to each wheel cylinder. In a vehicle, the fluid reservoir is commonly referred to as the master cylinder, and the brake fluid is a hydraulic liquid. The present invention, however, is also applicable to other types of fluid systems, including pneumatic systems.

The brake system also includes a pressure source that acts upon the fluid in the system for increasing the pressure throughout the system. In a vehicle, the pressure source is generally a piston located within the master cylinder. Braking is effected by displacing the piston in the master cylinder, thus pressurizing the entire brake system.

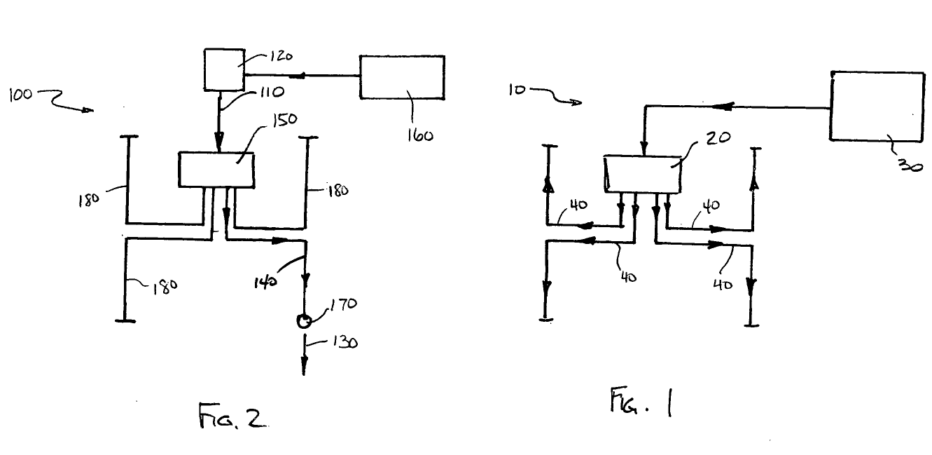

Referring to FIGS. 1 and 2, in order to detect leaks in the system, the present invention contemplates adding a dye that is designed to fluoresce when exposed to light of a certain wavelength to the brake fluid. In a first aspect of the invention, the dye is added to or mixed with the brake fluid at the time that the fluid is first introduced to the system. For example, the dye can be mixed with the brake fluid when the brake system is first assembled and filled with the brake fluid. In this embodiment, the dye will remain essentially dormant in the system until such time as a leak develops. The dye will escape out with the leaking brake fluid.

Since the dye is designed to stay contained within the brake system during normal brake operation, the dye must be selected so as to not adversely impair the characteristics of the brake fluid, and should not adversely affect the components of the brake system, such as the seals in the wheel cylinders.

The dye in the present invention should be selected which will provide sufficient fluorescence in the brake fluid it is mixed with. The present invention expressly contemplates mixing of dyes with any conventional brake fluid, including mineral, vegetable, glycol and silicone oils.

If in dry form, the dye should be thoroughly soluble in the brake fluid with which it is to be used. If in liquid form, the dye should mix thoroughly with the intended brake fluid. It is also desirable for the dye to remain in solution (i.e., mixed) with the brake fluid so as to be properly detectable when a leak occurs, which can be years after it is added to the system.

Dyes that are suitable for use in the present invention are described in U.S. Pat. Nos. 5,650,563 and 6,165,384, the disclosures of which are incorporated herein by reference in their entirety. In one embodiment of the invention, the dye is a naphthoxanthene, perylene or naphthalene compound, such as:
Naphtho{3,2,1-kl}xanthene-2,8-dialkyl
3,9-perylenedialkylacetate
4-alkylamino-n-alkyl-naphthalimide
Dinaphtho(1,2,3-cd; 1′2′3-1m)perylene-9,18-dione, alkyl derivatives.

It has been determined that naphthalimide dyes provide very bright fluorescence and do not separate much over time when mixed with many brake fluids. Naphthalimide dyes have been used in recent years for detecting leaks in air conditioning systems. The components in a brake system are made from similar materials and, thus, no adverse deterioration should occur.

It is also contemplated that combinations of both perylene and naphthalimides dyes, blended in proportions, can be used as the selected dye in order to provide effective fluorescence over a range of excitation, as described in U.S. Pat. No. 6,165,384, the disclosure of which is incorporated herein by reference in its entirety.

The concentration of dye to be added to the brake fluid will vary depending on many factors, including the formulation of the brake fluid and the dye. The concentration of the dye can be engineered to accommodate different ranges of applications. For example, a service dosage of a convenient bottle size could be a ¼ ounce dose into a 1-quart braking system, which results in a 128:1 dilution ratio. A larger or smaller dose may be used instead. Dose sizes from ⅛ oz to 1 oz may provide a manageably sized dose without adding an undue amount of extra fluid to the brake system. If the dye is a higher concentration, then less is needed, for example, a 2500:1 dilution ratio. Factors such as desired brilliance of fluorescence, the natural color and fluorescence of the brake fluids, the type of dye used and the fluid capacity of the brake systems will all impact these numbers.

It has also been determined that some brake fluids will accept water soluble dyes. These dyes would not be water based but, instead, would be formulated with glycol based or similar fluids. Thus, the present invention contemplates the use of uranine, stylbene, xanthene or other water miscible dyes, either alone or in combination with one another or other compositions. Uranine has a very strong visible color as well as an excellent fluorescent response. It can be used in minute quantities to provide some fluorescent activity in the green color to make a dye's fluorescence visible with yellow spectacles.

Where the dye if formulated in a carrier liquid as a dose to be added to the braking system, the carrier liquid may be brake fluid or a similar fluid that can be added to brake fluid without impairing the performance of the brake fluid, such as DOT-3 glycol based brake fluid, DOT-4 borate ester based brake fluid, DOT-5 silicone based brake fluid, vegetable based fluids, natural oil based fluids, and so on.

The dye can be added to the system in several ways. First, the dye could be provided as a concentrated pill, tablet, powder, liquid or wafer that is placed within the master cylinder 20 of the brake system 10 prior to the addition of the brake fluid. When the brake fluid is added by the OEM, it will cause the dye to begin to dissolve and mix with the entering fluid.

More preferably, the dye concentrate is added to the brake fluid reservoir that the OEM uses to fill the brake systems. In this embodiment, the dye can again be added as either a concentrated pill, tablet, powder, liquid or wafer, in a sufficient amount to mix with the fluid within a reservoir or other containment vessel 30. The dye could be added by the OEM or by the supplier of the brake fluid prior to shipment to the OEM.

The dyed fluid is channeled through the various brake lines 40 in the system until the brake system 10 is completed filled with the dyed brake fluid. Once filled, the dyed brake fluid stays in that state until a leak develops, at which point the dye will leak out with the brake fluid. In order to detect the dye, a UV or blue light source is used to illuminate the various parts of the brake system. The light sources typically produce light having a wavelength below 500 nm. UV-A light generally has a wavelength from about 315 nm to about 400 nm. Blue light sufficient to produce fluorescence has a wavelength from about 400 nm to about 480 nm. When the light illuminates the dye, the dye will fluoresce, indicating the source of the leak.

A wide variety of inspection lamps are available for use with the present invention, and which emit light with a suitable wavelength, including within the UV-A and visible violet/blue ranges. Suitable inspection lamps are available from Spectronics Corporation, Westbury, N.Y. U.S. Pat. Nos. 5,816,692, 5,905,268, 5,997,154 and 6,491408 all disclose various inspection lamps that have use in the present invention. These patents are all incorporated herein by reference in their entireties.

Thus, the present invention provides a novel system for detecting leaks in a brake system by introducing a dyed brake fluid into the system when it is first manufactured (or after a servicing).

Referring now to FIG. 2, in order to provide for leak detection in vehicles with existing brake systems 100 that do not have the OEM installed dyed brake fluid, the present invention contemplates introducing the dyed brake fluid 110 into the brake system 100 when the vehicle is being repaired or serviced. In this embodiment, it is necessary to replace the fluid in part of or the entire brake system 100 with the dyed brake fluid 110. This can be accomplished using a brake fluid flush system 120. These systems are used to force the brake fluid 130 out of a brake line 140.

The dye is added to a new brake fluid as discussed above by either adding the dye to the master cylinder 150 or into a reservoir of brake fluid 160. One end 170 of a brake line 140, such as the connection of the brake line to a wheel cylinder, is opened for draining. Dyed brake fluid 110 is added to the brake system and the system is pressurized, either by pumping the brake pedal (thus actuating the master cylinder), or by introducing the dyed brake fluid into the system under pressure, such as with a brake flush system 120. In this later embodiment, the pressure is generally controlled so as to be less than the maximum pressure that the system is designed to withstand in order to prevent damage to the system components.

As pressure is applied, the dyed brake fluid 110 will flow through the open line 140 of the system 100. By illuminating the end of the line with the UV or blue light, the service personnel can determine when the dyed brake fluid 110 has completely replaced the prior brake fluid 130. That line 140 could then be inspected for leaks using a suitable light source, such as a UV or blue light. If no leak is detected, the line 140 is reconnected to the wheel cylinder and the wheel cylinder is inspected for leaks. If the wheel cylinder is not leaking, the procedure is repeated on the other brake lines 180 until the leak is detected.

Alternatively, the prior brake fluid 130 is drained through the open end 170 before the dyed brake fluid 110 is introduced into the brake line 140.

Thus, this alternate embodiment of the invention provides a novel method of detecting leaks in an existing brake system by introducing the dyed brake fluid into a system that includes non-dyed brake fluid.

It is also contemplated that dyes with improved solubility characteristics can be applied to the non-circulating fluid braking systems as service dosages. These can be applied into the master cylinder and the turbulence generated from the oscillating motion of the fluid in the brake lines will allow them to travel throughout the system over time. In this manner, a small bottle of dye can be poured into a braking system and, given time, reaches even to the farthest components of the system.

While the above discussion has described the invention for use in a brake system of a vehicle, it should be readily apparent that the present invention has application in any device that has a brake system with non-circulating fluids. Thus, the above description simply recites one preferred embodiment.

1. A dyed brake fluid product for use in a non-circulating brake system, the dyed brake fluid product comprising:
a container;
a brake fluid in the container; and
a dye mixed with the brake fluid in the container, the dye having material properties which produce fluorescence when exposed to a light of a prescribed wavelength.

2. A dyed brake fluid product according to claim 1, wherein the dye comprises at least one dye selected from the group consisting of naphthoxanthene, perylene, and naphthalene compounds and mixtures thereof.

3. A dyed brake fluid product according to claim 1, wherein the dye comprises at least one dye selected from the group consisting of: naphtho{3,2,1-kl}xanthene-2,8-dialkyl; 3,9-perylenedialkylacetate; 4-alkylamino-n-alkyl-naphthalimide; and dinaphtho(1,2,3-cd; 1′2′3-1m)perylene-9,18-dione, alkyl derivatives.

4. A method of detecting leaks in a brake system, the method comprising the steps of:
introducing a dyed brake fluid into a brake system; and
illuminating various portions of the brake system with a light having a wavelength below about 500 nm, the light designed to cause the dye within the brake fluid to fluoresce when illuminated, thus indicating the leak.

5. A method of detecting leaks in a brake system according to claim 4 wherein the dyed brake fluid is introduced into a new brake system which is devoid of brake fluid, the dyed brake fluid substantially filling the brake system.

6. A method of detecting leaks in a brake system according to claim 4 wherein the dyed brake fluid is introduced into a brake system that already includes brake fluid, the method involving opening at least one end of the brake system, and emptying existing brake fluid out of the open end of the brake system, and wherein the step of introducing the dyed brake fluid involves filling a portion of the brake system leading to the open end.

7. A method of detecting leaks in a brake system according to claim 6 wherein the step of emptying takes place prior to the step of introducing the dyed brake fluid.

8. A method of detecting leaks in a brake system according to claim 6 wherein the steps of emptying and filling comprise displacing the existing brake fluid with the dyed brake fluid.

9. A method of detecting leaks in a brake system according to claim 8, wherein the step of introducing the dyed brake fluid further comprises illuminating the open end with light having a wavelength below about 500 nm; monitoring the fluid being emptied out of the open end for fluorescence; and closing the open end when brake fluid that fluoresces emerges from the open end.

10. A method of filling a brake system with leak detection brake fluid, the method comprising the steps of:
providing a mixture of dyed brake fluid; and
introducing the dyed brake fluid into at least a portion of the brake system.

11. A method of filling a brake system according to claim 10 wherein the dyed brake fluid is introduced into a new brake system which is devoid of brake fluid, the dyed-brake fluid substantially filling the brake system.

12. A method of filling a brake system according to claim 10 wherein the dyed brake fluid is introduced into a brake system that already includes brake fluid, the method involving opening at least one end of the brake system, and emptying existing brake fluid out of the open end, and wherein the step of introducing the dyed brake fluid involves filling a portion of the brake system leading to the open end.

13. A method of filling a brake system according to claim 12 wherein the step of emptying takes place prior to the step of introducing the dyed brake fluid.

14. A method of filling a brake system according to claim 12 wherein the steps of emptying and filling comprise displacing the existing brake fluid with the dyed brake fluid.

15. A method of filling a brake system according to claim 14, wherein the steps of emptying and filling further comprise illuminating the open end with light having a wavelength below about 500 nm; monitoring the fluid being emptied out of the open end for fluorescence; and closing the open end when brake fluid that fluoresces emerges from the open end.

16. A method of detecting leaks in a non-circulating brake fluid system, the method comprising the steps of:
introducing a dosage of a dye containing a fluorescent material into a brake system containing a brake fluid;
operating the brake system to cause the dye to travel and disperse through the system; and
illuminating various portions of the brake system with a light having a wavelength below about 500 nm, the light designed to cause the dye within the brake fluid to fluoresce when illuminated, thus indicating a leak source.

17. A non-circulating brake system, comprising:
a brake fluid in the brake system; and
a dye mixed with the brake fluid in the container, the dye having material properties that produce fluorescence.

18. A dyed brake fluid manufacture according to claim 17 in combination with a vehicle wherein said brake system is arranged to brake said vehicle.
